(19) United States
(12) Patent Application Publication
(10) Pub. No.: US 2013/0148867 A1
(43) Pub. Date: Jun. 13, 2013

(54) EXTERNAL CONTROLLER AND METHOD FOR DELAYING SCREEN LOCKING OF COMPUTING DEVICE

(71) Applicant: HUA-YONG WANG, Shenzhen (CN)

(72) Inventor: HUA-YONG WANG, Shenzhen (CN)

(21) Appl. No.: 13/684,476

(22) Filed: Nov. 23, 2012

(30) Foreign Application Priority Data
Dec. 9, 2011 (CN) 201110408360.1

(51) Int. Cl. G06F 21/32; G06K 9/00; G10L 17/22

(52) U.S. Cl. CPC G06F 21/32; G10L 17/22; G06K 9/00288
USPC 382/118; 704/275; 726/17; 726/19

(57) ABSTRACT

An external controller for delaying screen locking of a computing device, the screen of the computing device is automatically locked after a preset period of inactivity of the computing device. The external controller includes a detection unit and a control unit. The detection unit accounts a period of time of how long the computing device is inactive, and detects whether at least one authorized user is in front of the screen when the accounted period of time is greater than a predetermined time period. The control unit generates a control command for interrupting the inactivity mode of the computing device to delay the screen from automatically locking for the preset period, when the at least one authorized user is detected in front of the screen.

### BACKGROUND

1. Technical Field

Embodiments of the present disclosure relate to security of computing system associated with screen locking technologies, and particularly to an external controller and a method for delaying screen locking of a computing device.

2. Description of Related Art

A computer screen may be automatically locked after a preset period of inactivity. In some particular situations, a user may only need to view information on the screen without any operation to the computer, and the user may need to manually unlock the screen to resume the session every time the screen is automatically locked. It is somewhat inconvenient for the user. Therefore, there is room for improvement in the art.

### BRIEF DESCRIPTION OF THE DRAWINGS

FIG. 1 illustrates a schematic block diagram of one embodiment of a computing device.

FIG. 2 is a flowchart of one embodiment of a method for delaying automatic screen locking of the computing device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

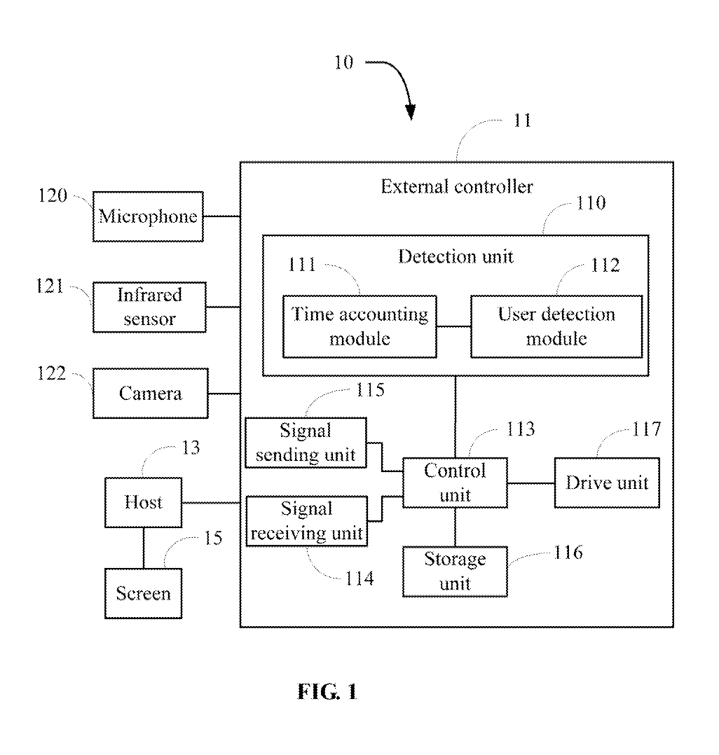

FIG. 1 illustrates a schematic block diagram of one embodiment of a computing device 10. The computing device 10 includes an external controller 11, a host 13, and a screen 15. The external controller 11 may wired or wirelessly communicate with the host 13 for operation with the host 13. The host 13 is a core portion of the computing device 10 that includes most components of the computing device 10, such as motherboard, CPU, memory, storage system, and others similar, for providing functions of the computing device 10. The computing device 10 may be, for example, a desktop computer, a laptop computer, or other similar computing device. In the embodiment, the screen 15 may be automatically locked by the host 13 after a pre-setting period (e.g., one minute) of inactivity of the computing device 10, and any operation to the computing device 10 is invalid when the screen 15 is locked.

The external controller 11, may be for example, a mouse, a keyboard, a remote control, or other input/output devices of the computing device 10. In the embodiment, the computing device 10 is regarded as inactive if no signal or command is received by the host 13 from any of I/O devices including the external controller 11 of the computing device 10. The external controller 11 includes a detection unit 110, a control unit 113, a signal sending unit 115, and a storage unit 116.

The detection unit 110 includes a time accounting module 111 and a user detection module 112. The time accounting module 111 accounts a period of time of how long the computing device 10 is inactive. When the accounted period of time is greater than a predetermined time period (e.g., 30 seconds), the user detection module 112 is activated to detect whether at least one authorized user is in front of the screen 15.

In the embodiment, the at least one authorized user has the authorization to view the screen 15 which may be predetermined by an owner or an administrator of the computing device 10. In the embodiment, the user detection module 112 first detects if a user is in front of the screen 15 using an infrared sensor 121. When a user is in front of the screen 15, the user detection module 112 determines whether the detected user is authorized to view the screen 15.

In one example, the user detection module 112 may be an audio analyzer which captures voices from the detected user in front of the screen 15 using a microphone 120, and compares the captured voices with at least one predetermined voiceprint to determine whether the detected user is authorized. The at least one predetermined voiceprint is obtained from the at least one authorized user and is prestored in the storage unit 116. In another embodiment, the user detection module 112 may be an image analyzer which captures a facial image of the detected user in front of the screen 15 using a camera 122, and compares the facial image with a predetermined facial image of the at least one authorized user to determine whether the detected user is authorized. In one embodiment, each of the microphone 120, infrared sensor 121, and camera 122 may be a component of the computing device 10 which is installed on the screen 15 and electrically connected to the external controller 11.

The control unit 113 generates a control command for interrupting the inactivity mode of the computing device 10, and sends the control command to the host 13 to delay the screen 15 from automatically locking for the preset period (e.g., one minute), when the at least one authorized user is detected in front of the screen 15. In the embodiment, the control unit 113 sends the control signal to the host 13 using the signal sending unit 115 which may be a wireless signal sending module or a wired signal sending module, such as a BLUETOOTH® module or a universal serial bus (USB) interface module, respectively.

In one embodiment, a plurality of predetermined commands for interrupting the inactivity mode of the computing device 10 may be prestored in the storage unit 116. Thus, the control unit 113 may generate the control command by randomly acquiring one of the predetermined commands from the storage unit 116. The acquired command is regarded as the control command

The external controller 11 further includes a signal receiving unit 114, to realize dual-communication between the external controller 11 and the host 13. In the embodiment, the time accounting module 111 may request the host 13 to feedback a signal indicating the period of time of how long the computing device 10 is inactive by sending a request message to the host 13 using the signal sending unit 115, and receive the signal from the host 13 using the signal receiving unit 114.

In a particular example of the external controller 11, the external controller 11 is a mouse. The mouse includes a drive unit 117 as shown in FIG. 1. The drive unit 117 may be, for example, a servomotor. When the accounted period of time is greater than the predetermined time period and the at least one authorized user is detected in front of the screen 15, the control unit 113 generates the control command by activating the servomotor and controlling the servomotor to slightly vibrate or move the mouse.

Thus, control command is automatically generated by the mouse and the cursor displayed on the screen 15 is automatically and slightly moved to interrupt the inactivity mode of the computing device 10. Thus, the automatic locking of the screen 15 is delayed for the preset period.

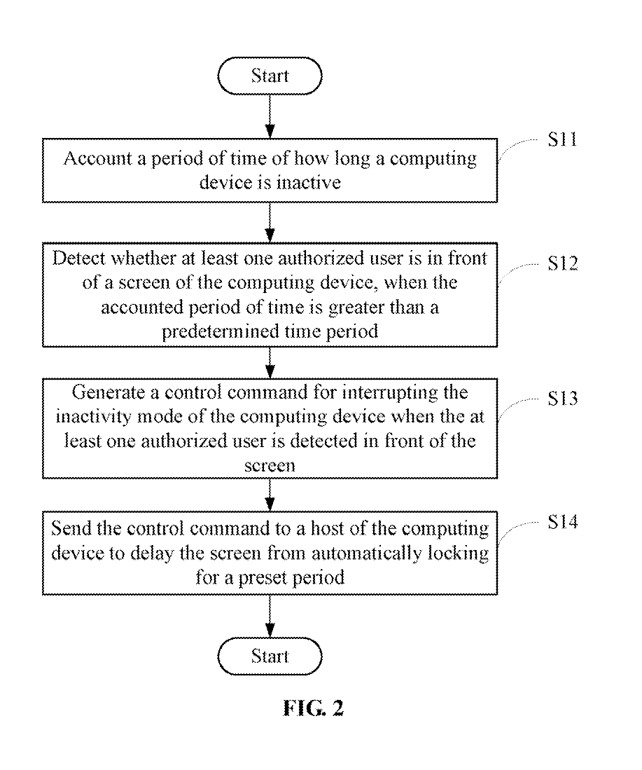

FIG. 2 is a flowchart of one embodiment of a method for delaying screen locking of the computing device 10. Depending on the embodiment, additional steps may be added, others removed, and the ordering of the steps may be changed.

In step S11, the time accounting module 111 accounts a period of time of how long the computing device 10 is inactive.

In step S12, when the accounted period of time is greater than a predetermined time period, the user detection module 112 detects whether at least one authorized user is in front of the screen 15.

In step S13, when the at least one authorized user is detected in front of the screen 15, the control unit 113 generates a control command for interrupting the inactivity mode of the computing device 10.

In step S14, the control unit 113 sends the control command to the host 13 using the signal sending unit 115 to delay the screen 15 from automatically locking for the preset period.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An external controller of a computing device having a screen, the screen of the computing device being automatically locked after a pre-set period of inactivity of the computing device, the external controller comprising:
a detection unit that accounts a period of time of how long the computing device is inactive, and detects whether at least one authorized user is in front of the screen when the accounted period of time is greater than a predetermined time period; and
a control unit that generates a control command for interrupting the inactivity mode of the computing device, and sends the control command to the computing device for delaying the screen from automatically locking for the pre-setting period, when the at least one authorized user is detected in front of the screen.

2. The external controller according to claim 1, further comprising:
a storage unit that stores a plurality of predetermined commands for interrupting the inactivity mode of the computing device.

3. The external controller according to claim 2, wherein the control command is generated by:
acquiring one of the predetermined commands from the storage unit, wherein the acquired command is regarded as the control command.

4. The external controller according to claim 1, wherein the external controller is a mouse that comprises a drive unit, and the control unit generates the control command by controlling the drive unit to vibrate or move the mouse.

5. The external controller according to claim 4, wherein the drive unit is a servomotor.

6. The external controller according to claim 1, wherein detection unit detects whether the at least one authorized user is in front of the screen by:
detecting if any user is in front of the screen using an infrared sensor; and
determining whether any detected user is authorized to view the screen according to at least one predetermined voiceprint or at least one facial image of the at least one authorized user.

7. The external controller according to claim 6, wherein the determining step comprises:
capturing voices from the detected user in front of the screen using a microphone; and
comparing the captured voices with the at least one predetermined voiceprint to determine whether the detected user is authorized to view the screen.

8. The external controller according to claim 6, wherein the determining step comprises:
capturing a facial image of the detected user in front of the screen using a camera; and
comparing the facial image with the predetermined facial image of the at least one authorized user to determine whether the detected user is authorized to view the screen.

9. A method for delaying screen locking of a computing device using an external controller, the screen of the computing device being automatically locked after a pre-setting period of inactivity of the computing device, the external controller comprising a detection unit and a control unit, the method comprising:
accounting a period of time of how long the computing device is inactive and detecting whether at least one authorized user is in front of the screen when the accounted period of time is greater than a predetermined time period using the detection unit; and
generating a control command for interrupting the inactivity mode of the computing device and sending the control command to the computing device using the control unit, to delay the screen from automatically locking for the preset period when the at least one authorized user is detected in front of the screen.

10. The method according to claim 9, wherein the external controller further comprises a storage unit that stores a plurality of predetermined commands for interrupting the inactivity mode of the computing device.

11. The method according to claim 10, wherein the generating step comprises:
acquiring one of the predetermined commands from the storage unit, the acquired command being regarded as the control command.

12. The method according to claim 9, where in the external controller is a mouse that comprises a drive unit, and the control command is generated by controlling the drive unit to vibrate or move the mouse.

13. The method according to claim 12, wherein the drive unit is a servomotor.

14. The method according to claim 9, wherein detecting step comprises:
detecting if any user are in front of the screen using an infrared sensor; and
determining whether any detected user is authorized to view the screen according to at least one predetermined voiceprint or at least one facial image of the at least one authorized user.

15. The method according to claim 14, wherein the determining step comprises:
capturing voices from the detected user in front of the screen using a microphone; and
comparing the captured voices with the at least one predetermined voiceprint to determine whether the detected user is authorized to view the screen.

16. The method according to claim 14, wherein the determining step comprises:
capturing a facial image of the detected user in front of the screen using a camera; and
comparing the facial image with the predetermined facial image of the at least one authorized user to determine whether the detected user is authorized to view the screen.
